(19) United States
(12) Patent Application Publication
(10) Pub. No.: US 2018/0213164 A1
(43) Pub. Date: Jul. 26, 2018

(54) Blood Vessel Positioning Device and Method Thereof

(71) Applicant: National Kaohsiung University of Applied Sciences, Kaohsiung (TW)

(72) Inventor: Gwo-Jia Jong, Kaohsiung (TW)

(21) Appl. No.: 15/414,680

(22) Filed: Jan. 25, 2017

(51) Int. Cl. H04N 5/33; G06T 7/00

(52) U.S. Cl. CPC H04N 5/33; G06T 2207/30101; G06T 2207/10048; G06T 7/0012

(57) ABSTRACT

A blood vessel positioning device includes an IR image capturing unit, an image-processing unit and an image projector unit. The IR image capturing unit is provided to capture an IR image of a skin area. The image-processing unit connects with the IR image capturing unit and the image projector unit. The image-processing unit is operated to process the IR image to seek thermal features in an image area of the IR image. A vessel pathway, vessel coordinate position or vessel depth of the image area is calculated with the thermal features. The vessel pathway, the vessel coordinate position or the vessel depth is further converted to a horizontal vessel image or a vertical vessel image which is projected onto the skin area by the image projector unit.

### BACKGROUND OF THE INVENTION

### 1. Field of the Invention

The present invention relates to a blood vessel (e.g. artery and vein) positioning device and method thereof. Particularly, the present invention relates to the blood vessel positioning and projecting device and method thereof for human being.

### 2. Description of the Related Art

U.S. Patent Application Publication No. 2011/0313294, entitled “Apparatus and method for determining the position of a vein or artery,” discloses a conventional apparatus for determining the position of a vein or artery with an IR light source. The IR light emerging from the member is scanned with a camera and the image is produced on a display adjacent to the camera. The camera and the display are mounted on a manoeuvrable arm which can be placed in any desired position relative to the member and observer. Displacement of the camera/display unit can be effected through the presence of a grip to be operated by the hand of the observer. If the quite position is found relative to the member, the hand of the observer can execute the related treatment to the vein or artery.

As a matter of fact, the arrangement of camera and display mounted on the maneuverable arm with the grip will complicate the entire apparatus. However, the observer requires manually adjusting the displacement of the camera/display unit for seeking the position of veins or arteries by his own hand. Furthermore, the observer requires continuously watching the display for confirming the position of veins or arteries which will affect executing the related treatment to the vein or artery via observing the display.

However, there is a need of improving and simplifying a conventional apparatus and method for determining the position of a vein or artery. The above-mentioned patent publication is incorporated herein by reference for purposes including, but not limited to, indicating the background of the present invention and illustrating the situation of the art.

As is described in greater detail below, the present invention provides a blood vessel positioning device and method thereof. A first IR image capturing unit and a second IR image capturing unit are operated to synchronously capture a first IR image and a second IR image which are processed by an image-processing unit to seek thermal features in an overlapped image area to obtain at least one vessel pathway, vessel coordinate position or vessel depth. The vessel pathway, the vessel coordinate position and the vessel depth are converted into a horizontal vessel image or a vertical vessel image for increasing the reliability of positioning the vessel in such a way as to mitigate and overcome the above problem.

### SUMMARY OF THE INVENTION

The primary objective of this invention is to provide a blood vessel positioning device and method thereof. A first IR image capturing unit and a second IR image capturing unit are operated to synchronously capture a first IR image and a second IR image which are processed by an image-processing unit to seek thermal features in an overlapped image area to obtain at least one vessel pathway, vessel coordinate position or vessel depth. The vessel pathway, the vessel coordinate position and the vessel depth are converted into a horizontal vessel image or a vertical vessel image. Advantageously, the blood vessel positioning device and method of the present invention is successful in increasing the reliability of positioning the vessel.

Another objective of this invention is to provide a blood vessel positioning device and method thereof. A first IR image capturing unit and a second IR image capturing unit are operated to synchronously capture a first IR image and a second IR image of a predetermined skin area which are processed by an image-processing unit to seek thermal features in an overlapped image area to obtain at least one vessel pathway, vessel coordinate position or vessel depth. The vessel pathway, the vessel coordinate position and the vessel depth are converted into a horizontal vessel image or a vertical vessel image which is further projected onto the predetermined skin area or other desired area synchronously or asynchronously. Advantageously, the blood vessel positioning device and method of the present invention is successful in increasing the reliability of positioning the vessel.

The blood vessel positioning method in accordance with an aspect of the present invention includes:

capturing a first IR image of a predetermined skin area with a first IR image capturing unit and synchronously capturing a second IR image of the predetermined skin area with a second IR image capturing unit;

processing the first IR image and the second IR image with an image-processing unit to seek thermal features in an overlapped image area of the first IR image and the second IR image;

calculating at least one vessel pathway, vessel coordinate position or vessel depth of the overlapped image area with the thermal features; and

converting the vessel pathway, the vessel coordinate position or the vessel depth into a horizontal vessel image or a vertical vessel image.

The blood vessel positioning method in accordance with another aspect of the present invention includes:

capturing an IR image of a predetermined skin area with an IR image capturing unit;

processing the IR image with an image-processing unit to seek thermal features in an image area of the IR image;

calculating at least one vessel pathway, vessel coordinate position or vessel depth of the image area with the thermal features;

converting the vessel pathway, the vessel coordinate position or the vessel depth into a horizontal vessel image or a vertical vessel image; and

projecting the horizontal vessel image or the vertical vessel image onto the predetermined skin area synchronously or asynchronously with a predetermined projection mode.

In a separate aspect of the present invention, the projection mode includes a white light projection mode, a width projection mode, a depth projection mode or a green light projection mode.

In a further separate aspect of the present invention, the horizontal vessel image or the vertical vessel image is output to a display unit.

In yet a further separate aspect of the present invention, the horizontal vessel image or the vertical vessel image is further output to a cloud server by a wireless transmission unit.

The blood vessel positioning device in accordance with an aspect of the present invention includes:

a first IR image capturing unit provided at a first predetermined position to capture a first IR image of a predetermined skin area;

a second IR image capturing unit provided at a second predetermined position to capture a second IR image of the predetermined skin area;

an image-processing unit connected with the first IR image capturing unit and the second IR image capturing unit, with the image-processing unit processing the first IR image and the second IR image to seek thermal features in an overlapped image area of the first IR image and the second IR image; and

an image output unit connected with the image-processing unit;

wherein at least one vessel pathway, vessel coordinate position or vessel depth of the overlapped image area is calculated with the thermal features and the vessel pathway, the vessel coordinate position or the vessel depth is converted to a horizontal vessel image or a vertical vessel image which is output to the image output unit.

The blood vessel positioning device in accordance with another aspect of the present invention includes:

an IR image capturing unit provided at a predetermined position to capture an IR image of a predetermined skin area;

an image-processing unit connected with the IR image capturing unit, with the image-processing unit processing the IR image to seek thermal features in an image area of the IR image; and

an image projector unit connected with the image-processing unit;

wherein at least one vessel pathway, vessel coordinate position or vessel depth of the image area is calculated with the thermal features and the vessel pathway, the vessel coordinate position or the vessel depth is converted to a horizontal vessel image or a vertical vessel image which is projected onto the predetermined skin area by the image projector unit.

In a separate aspect of the present invention, the image-processing unit connects with a wireless transmission unit and the horizontal vessel image or the vertical vessel image is further output to a cloud server by the wireless transmission unit.

In a further separate aspect of the present invention, the image-processing unit connects with a data storage unit to store the horizontal vessel image or the vertical vessel image.

In yet a further separate aspect of the present invention, the image projector unit includes a white-light projector unit or a green-light projector unit.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a blood vessel positioning method in accordance with a first preferred embodiment of the present invention.

FIG. 2 is a block diagram of a blood vessel positioning device in accordance with the first preferred embodiment of the present invention.

FIG. 3 is a flow chart of a blood vessel positioning method in accordance with a second preferred embodiment of the present invention.

FIG. 4 is a block diagram of a blood vessel positioning device in accordance with the second preferred embodiment of the present invention.

FIG. 5 is a schematic view of the blood vessel positioning device in accordance with the first preferred embodiment of the present invention.

FIGS. 6(a)-6(c) are a series of schematic views of three projection modes projected on a palm back from the blood vessel positioning device in accordance with the second preferred embodiment of the present invention.

FIG. 7 is a horizontal vessel image captured from a skin area of a wrist by the blood vessel positioning device in accordance with the second preferred embodiment of the present invention.

### DETAILED DESCRIPTION OF THE INVENTION

It is noted that a blood vessel positioning device and method thereof in accordance with the present invention can be applicable for various blood vessel detection auxiliary devices, blood vessel pathological diagnosis devices and related equipment, including medical injection systems, blood transfusion systems, blood test systems, home care systems, medical appliance automatic control systems (e.g. medical check systems), remote medical care systems or medical education systems, for example, which are not limitative of the present invention.

FIG. 1 shows a flow chart of a blood vessel positioning method in accordance with a first preferred embodiment of the present invention. Referring now to FIG. 1, the blood vessel positioning method of the first preferred embodiment of the present invention includes the step S1: capturing a first IR image of a predetermined skin area (e.g. wrist portion of human being) with a first IR image capturing unit (e.g. IR camera) and synchronously capturing a second IR image of the predetermined skin area with a second IR image capturing unit.

With continued reference to FIG. 1, the blood vessel positioning method of the first preferred embodiment of the present invention includes the step S2: processing the first IR image and the second IR image with a predetermined algorithm of an image-processing unit to seek at least one or several thermal features (i.e. skin surface temperature) in an overlapped image area of the first IR image and the second IR image.

With continued reference to FIG. 1, the blood vessel positioning method of the first preferred embodiment of the present invention includes the step S3: the image-processing unit or other data-processing unit selectively calculating at least one vessel pathway, vessel coordinate position or vessel depth of the overlapped image area with the thermal features (e.g. grayscale variations in IR image), with retrieving discontinuous features on edges of the overlapped image area.

With continued reference to FIG. 1, the blood vessel positioning method of the first preferred embodiment of the present invention includes the step S4: the image-processing unit or other data-processing unit converting data of the vessel pathway, the vessel coordinate position or the vessel depth into a horizontal vessel image or a vertical vessel image which can indicate pathways, coordinate positions and depths of the blood vessels on the vessel image.

By way of example, the blood vessel positioning method of the first preferred embodiment can process the horizontal vessel image and the vertical vessel image with a digital video interface (DVI), a high definition multimedia interface (HDMI) or other equivalent manner to increase rates of image transmission and image resolution.

FIG. 2 shows a block diagram of a blood vessel positioning device for executing the blood vessel positioning method in accordance with the first preferred embodiment of the present invention. Referring now to FIG. 2, the blood vessel positioning device of the first preferred embodiment of the present invention includes a first IR image capturing unit 11, a second IR image capturing unit 12, an image-processing unit 20, an image storage unit 30 and an image output unit 40.

Still referring to FIG. 2, the first IR image capturing unit 11 and the second IR image capturing unit 12 are selected from an IR camera, a miniature IR camera, a high-speed IR camera or other equivalent device which is operated to capture at least one first IR image and at least one second IR image of a predetermined skin area. The IR image capturing unit and the second IR image capturing unit 12 connects with the image-processing unit 20.

Still referring to FIG. 2, the image-processing unit 20 is provided to process the first IR image and the second IR image with a predetermined algorithm to seek thermal features in an overlapped image area of the first IR image and the second IR image. In addition, vessel pathways, vessel coordinate positions or vessel depths of the overlapped image area are calculated with the thermal features and are further converted to a horizontal vessel image or a vertical vessel image.

Still referring to FIG. 2, the image storage unit 30 is selected from a memory device or other equivalent device. The image storage unit 30 connects with the image-processing unit 20 to store the vessel pathways, the vessel coordinate positions, the vessel depths, the horizontal vessel image and the vertical vessel image in the image storage unit 30.

Still referring to FIG. 2, the image output unit 40 is selected from a display device or other equivalent device (e.g. large-scale display screen, personal computer display or TV). The image output unit 40 connects with the image-processing unit 20 to display the horizontal vessel image and the vertical vessel image with a predetermined display mode, including a white light display mode, a width display mode, a depth display mode, a green light display mode or combinations thereof.

FIG. 3 is a flow chart of a blood vessel positioning method in accordance with a second preferred embodiment of the present invention. Referring now to FIG. 3, the blood vessel positioning method of the second preferred embodiment of the present invention includes the step S1: capturing at least one or a series of IR image of a predetermined skin area (e.g. wrist portion of human being) with an IR image capturing unit (e.g. IR camera).

With continued reference to FIG. 3, the blood vessel positioning method of the second preferred embodiment of the present invention includes the step S2: processing the IR image with a predetermined algorithm of an image signal processor (ISP) to seek at least one or several thermal features (i.e. skin surface temperature) in an image area of the IR image.

With continued reference to FIG. 3, the blood vessel positioning method of the second preferred embodiment of the present invention includes the step S3: the image signal processor or other data-processing unit selectively calculating at least one vessel pathway, vessel coordinate position or vessel depth of the image area with the thermal features (e.g. grayscale variations in IR image).

With continued reference to FIG. 3, the blood vessel positioning method of the second preferred embodiment of the present invention includes the step S4: the image signal processor or other data-processing unit converting data of the vessel pathway, the vessel coordinate position or the vessel depth into a horizontal vessel image or a vertical vessel image which can indicate pathways, coordinate positions and depths of the blood vessels on the vessel image.

With continued reference to FIG. 3, the blood vessel positioning method of the second preferred embodiment of the present invention includes the step S5: projecting the horizontal vessel image or the vertical vessel image onto the predetermined skin area with a predetermined projection mode synchronously or asynchronously.

FIG. 4 is a block diagram of a blood vessel positioning device in accordance with the second preferred embodiment of the present invention. Referring now to FIG. 4, the blood vessel positioning device of the second preferred embodiment of the present invention includes an IR image capturing unit 10, an image-processing unit 20, an image storage unit 30, an image projection unit 41 and a wireless transmission unit 50.

Still referring to FIG. 4, the IR image capturing unit 10 is selected from an IR camera, a miniature IR camera, a high-speed IR camera or other equivalent device which is operated to capture at least one or a series of IR images of a predetermined skin area. The IR image capturing unit 10 connects with the image-processing unit 20 or the IR image capturing unit 10 and the image-processing unit 20 are incorporated into a single device.

Still referring to FIG. 4, the image-processing unit 20 is provided to process the IR images with a predetermined algorithm to seek thermal features in an image area of the IR image. In addition, vessel pathways, vessel coordinate positions or vessel depths of the overlapped image area are calculated with the thermal features and are further converted to a horizontal vessel image or a vertical vessel image.

Still referring to FIG. 4, the image storage unit 30 is selected from a memory device or other equivalent device. The image storage unit 30 connects with the image-processing unit 20 to store the vessel pathways, the vessel coordinate positions, the vessel depths, the horizontal vessel image and the vertical vessel image in the image storage unit 30.

Still referring to FIG. 4, the image projection unit 41 is selected from a projector device or other equivalent device (e.g. portable projector or miniature projector (handset)). The image projection unit 41 connects with the image-processing unit 20 to project the horizontal vessel image and the vertical vessel image with a predetermined projection mode onto the predetermined skin area or on a screen synchronously or asynchronously for an observer.

With continued reference to FIG. 4, by way of example, according to various needs, the predetermined projection mode includes a white light projection mode, a width projection mode, a depth projection mode, a green light projection mode or combinations thereof with a white-light projector unit or a green-light projector unit.

Still referring to FIG. 4, the wireless transmission unit 50 is selected from various wireless transmission modules (e.g. short-range wireless transmission module or medium-range wireless transmission module). The wireless transmission unit 50 connects with the image-processing unit 20 and the image storage unit 30. In image data transmission, the wireless transmission unit 50 is operated to output the horizontal vessel image or the vertical vessel image to a cloud server. In wireless transmission, a digital video/image communication interface is applied to preset image capturing positions, addresses of connection (e.g. IP address) or other items.

With continued reference to FIG. 4, by way of example, the cloud server includes an image interface system and a database system. The image interface system includes an image interface and an image processing system. The database system further includes an image storage unit and an image classification unit.

FIG. 5 is a schematic view of the blood vessel positioning device in accordance with the first preferred embodiment of the present invention. Referring now to FIG. 5, the blood vessel positioning device includes an IR image capturing system which further includes a first IR sensor unit 11a and a second IR sensor unit 12a. The first IR sensor unit 11a has a first inclination while the second IR sensor unit 12a has a second inclination such that a first IR image of the first IR sensor unit 11a and a second IR image of the second IR sensor unit 12a are overlapped at a predetermined skin area (e.g. palm back) to obtain an overlapped image area, as best shown by dotted lines in FIG. 5.

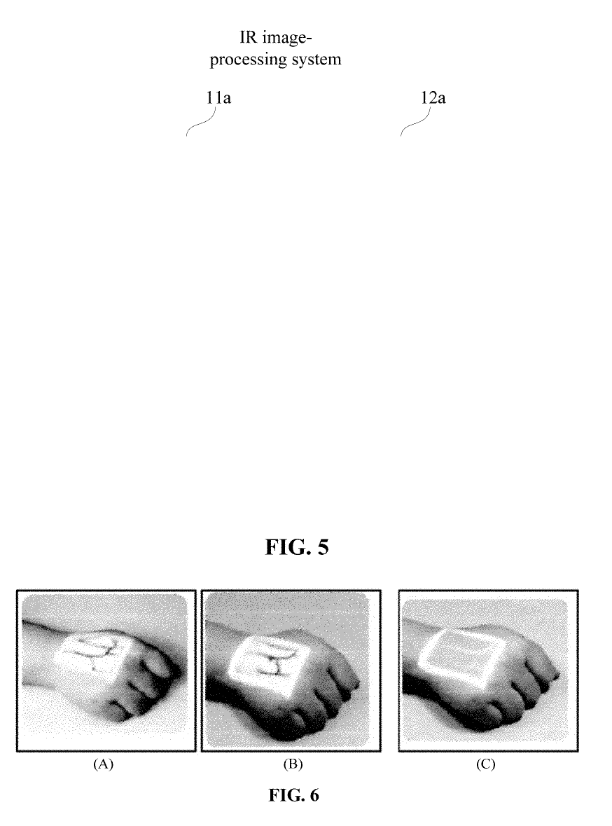

FIGS. 6(a)-6(c) are a series of schematic views of three projection modes projected on a palm back from the blood vessel positioning device in accordance with the second preferred embodiment of the present invention. Referring now to FIGS. 4 and 6(a), the image projection unit 41 has a white light projection mode to directly project a white light blood vessel pathway image on its own palm back. Turning now to FIGS. 4 and 6(b), the image projection unit 41 has a depth projection mode to directly project a blood vessel depth image on its own palm back. Turning now to FIGS. 4 and 6(c), the image projection unit 41 has a green light projection mode to directly project a green light blood vessel pathway image on its own palm back.

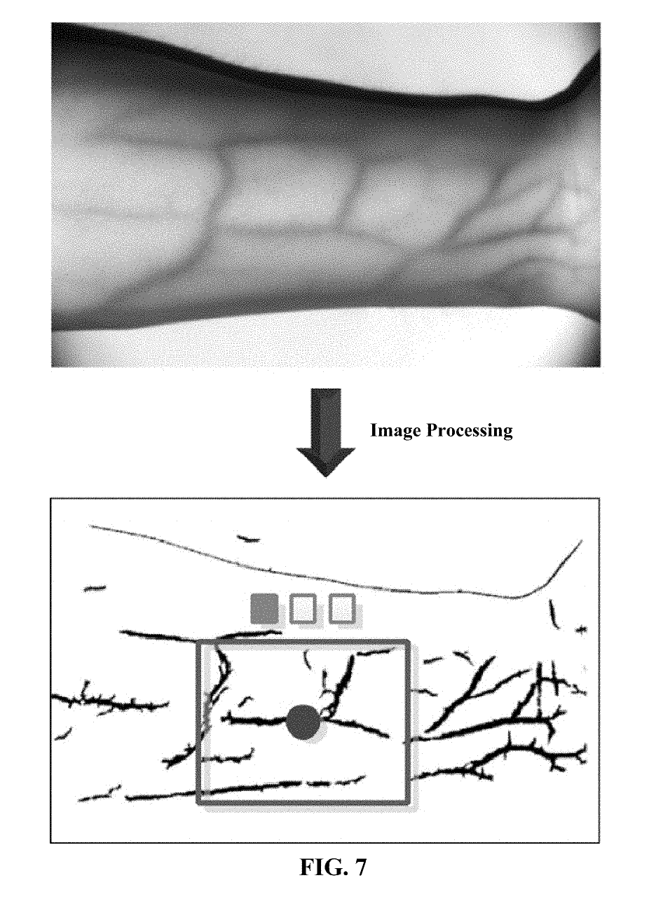

FIG. 7 is a horizontal vessel image captured from a skin area of a wrist by the blood vessel positioning device in accordance with the second preferred embodiment of the present invention. Referring now to FIGS. 2 and 7, the image-processing unit 20 is operated to process an IR wrist image (as best shown at upper portion in FIG. 7) and generates a blood vessel pathway image marked with an injection point, as best shown at lower portion in FIG. 7.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A blood vessel positioning method comprising:
capturing an IR image of a predetermined skin area with an IR image capturing unit;
processing the IR image with an image-processing unit to seek thermal features in an image area of the IR image;
calculating at least one vessel pathway, vessel coordinate position or vessel depth of the image area with the thermal features; and
converting the vessel pathway, the vessel coordinate position or the vessel depth into a horizontal vessel image or a vertical vessel image.

2. The blood vessel positioning method as defined in claim 1, wherein the horizontal vessel image or the vertical vessel image is projected onto the predetermined skin area synchronously or asynchronously with a predetermined projection mode.

3. The blood vessel positioning method as defined in claim 2, wherein the projection mode includes a white light projection mode, a width projection mode, a depth projection mode or a green light projection mode.

4. The blood vessel positioning method as defined in claim 1, wherein the horizontal vessel image or the vertical vessel image is output to a display unit.

5. The blood vessel positioning method as defined in claim 1, wherein the horizontal vessel image or the vertical vessel image is output to a cloud server by a wireless transmission unit.

6. A blood vessel positioning method comprising:
capturing a first IR image and a second IR image of a predetermined skin area with a first IR image capturing unit and a second IR image capturing unit synchronously;
processing the first IR image and the second IR image with an image-processing unit to seek thermal features in an overlapped image area of the first IR image and the second IR image;
calculating at least one vessel pathway, vessel coordinate position or vessel depth of the overlapped image area with the thermal features; and
converting the vessel pathway, the vessel coordinate position or the vessel depth into a horizontal vessel image or a vertical vessel image.

7. The blood vessel positioning method as defined in claim 6, wherein the horizontal vessel image or the vertical vessel image is projected onto the predetermined skin area synchronously or asynchronously with a predetermined projection mode.

8. The blood vessel positioning method as defined in claim 7, wherein the projection mode includes a white light projection mode, a width projection mode, a depth projection mode or a green light projection mode.

9. The blood vessel positioning method as defined in claim 6, wherein the horizontal vessel image or the vertical vessel image is output to a display unit.

10. The blood vessel positioning method as defined in claim 6, wherein the horizontal vessel image or the vertical vessel image is output to a cloud server by a wireless transmission unit.

11. A blood vessel positioning device comprising:
an IR image capturing device provided at a predetermined position to capture at least one IR image of a predetermined skin area;
an image-processing unit connected with the IR image capturing device, with the image-processing unit processing the IR image to seek thermal features in an image area of the IR image; and
an image output unit connected with the image-processing unit;
wherein at least one vessel pathway, vessel coordinate position or vessel depth of the image area is calculated with the thermal features and the vessel pathway, the vessel coordinate position or the vessel depth is converted to a horizontal vessel image or a vertical vessel image.

12. The blood vessel positioning device as defined in claim 11, wherein an image projector unit is operated to project the horizontal vessel image or the vertical vessel image onto the predetermined skin area.

13. The blood vessel positioning device as defined in claim 12, wherein the image projector unit includes a white-light projector unit or a green-light projector unit.

14. The blood vessel positioning device as defined in claim 11, wherein the image-processing unit connects with a wireless transmission unit and the horizontal vessel image or the vertical vessel image is output to a cloud server by the wireless transmission unit.

15. The blood vessel positioning device as defined in claim 11, wherein the image-processing unit connects with a data storage unit to store the horizontal vessel image or the vertical vessel image.

16. The blood vessel positioning device as defined in claim 11, wherein the IR image capturing device includes a first IR image capturing unit operated to capture the at least one IR image as a first IR image and a second IR image capturing unit operated to capture a second IR image of the predetermined skin area, with processing the first IR image and the second IR image with the image-processing unit to seek the thermal features in an overlapped image area of the first IR image and the second IR image.

17. The blood vessel positioning device as defined in claim 16, wherein an image projector unit is operated to project the horizontal vessel image or the vertical vessel image onto the predetermined skin area.

18. The blood vessel positioning device as defined in claim 17, wherein the image projector unit includes a white-light projector unit or a green-light projector unit.

19. The blood vessel positioning device as defined in claim 16, wherein the image-processing unit connects with a wireless transmission unit and the horizontal vessel image or the vertical vessel image is output to a cloud server by the wireless transmission unit.

20. The blood vessel positioning device as defined in claim 16, wherein the image-processing unit connects with a data storage unit to store the horizontal vessel image or the vertical vessel image.
